(19) United States
(12) Patent Application Publication
(10) Pub. No.: US 2026/0370490 A1
(43) Pub. Date: Nov. 19, 2026

(54) SYSTEM, METHOD AND APPARATUS TO OPERATE DECENTRALIZED LEDGERS OVER INTERMITTENTLY-CONNECTED NETWORKS

(71) Applicant: Beyond Aerospace Ltd., Kelowna (CA)

(72) Inventors: Krishnanunni Unnikannan, Toronto (CA); Oliver Michaelis, San Diego, CA (US)

(21) Appl. No.: 19/210,125

(22) Filed: May 16, 2025

(51) Int. Cl. H04L 9/32; H04L 9/00

(52) U.S. Cl. CPC H04L 9/3247; H04L 9/50

(57) ABSTRACT

A system, method and apparatus are described for facilitating assured data exchanges in a decentralized network among intermittently-connected ledger nodes. A forward ledger channel is formed, containing all orderer nodes of a first blockchain network, at least two peer nodes of the first blockchain network, and a plurality of peer nodes of a second blockchain network. A reverse ledger channel is also formed, containing all orderer nodes of the second blockchain network, at least two peer nodes of the second blockchain network, and a plurality of peer nodes of the first blockchain network. When the networks are disconnected, each network may publish cryptographic blocks onto the forward and reverse channels, respectively. When the networks later become connected to each other, any blocks published on the forward or reverse channel become available for replication to peer nodes in the second network and peer nodes in the first network, respectively.

### BACKGROUND

### I. Field of Use

The present invention relates to the field of blockchain technology and more specifically to a system, method and apparatus for operating decentralized ledgers over intermittently-connected networks.

### II. Description of the Related Art

Blockchain technology has exploded into the mainstream recently, underlying the technology of cryptocurrencies. Blockchain technology utilizes encrypted, distributed, digital ledgers that record digital transactions that occur between two or more entities over the Internet. Multiple “nodes” in a blockchain network each keep a copy of a distributed ledger, and when a digital transaction occurs, each node, or a majority of nodes, in the network attempts to validate the transaction. When the transaction is validated by each of the validating nodes, it sends proof of the validation to the other nodes. Once a majority of the nodes agree that the proof is valid, the transaction is added to a plurality of other validated transactions, and a new “block” is written to the distributed ledger and updated on all of the nodes.

While blockchain technology is well-known, used as the technological backbone of digital cryptocurrencies, it may be used in other applications, such as voting, identification, data management and distribution, data storage, and many others.

In typical blockchain deployments, the participating nodes are presumed to be in a well-connected network environment such as a data center. Permissioned, enterprise ledgers may support cryptographically-separated ledger channels, which are configured to monitor the presence of their peers on the channel continuously and automatically remove peers that appear offline. Furthermore, gateways submitting new transaction proposals view the nodes constituting a ledger channel as a single pool, i.e. connectivity to sufficient peers and orderers for the purpose of processing a transaction is also assumed. In a typical ledger channel, a set of peers and orderers facilitate the processing, validation, and publishing of transactions in the form of ledger blocks. A channel is configured in such a way that all peers and all orderers of the Pool are collocated within a well-connected network topology, enabling the processing and publishing of transactions.

In an intermittently-connected network topology, however, the above assumptions are not valid, so there is presently no way to keep a ledger updated when some peers become disconnected from a main group of peers and both the main group of peers and the disconnected peers each function independently when disconnected.

### SUMMARY

The embodiments herein describe systems, methods and apparatus for facilitating assured data exchanges in a decentralized network among intermittently-connected ledger nodes. In one embodiment, a system is described, comprising a plurality of peer nodes of a core blockchain network, a plurality of orderer nodes of the core blockchain network, a plurality of peer nodes of a nomad blockchain network, a plurality of orderer nodes of the nomad blockchain network, a channel gateway for creating a cryptographically-separated, forward logical channel and a cryptographically-separated, reverse logical channel, and for assigning all of the plurality of orderer nodes of the core blockchain network, at least two peer nodes of the core blockchain network, and the plurality of peer nodes of the nomad blockchain network to the forward logical channel and for assigning all of the orderer nodes of the nomad blockchain network, at least two peer nodes of the nomad blockchain network and the plurality of peer nodes of the core blockchain network to the reverse logical channel, wherein when the core blockchain network and the nomad blockchain network are disconnected from each other, a first peer node of the core blockchain network publishes a first cryptographic block on the forward channel and a first peer node of the nomad blockchain network publishes a second cryptographic block on the reverse channel, and when the core blockchain network and the nomad blockchain network are re-connected to each other after the first cryptographic block and the second cryptographic block have been published, a second peer node of the nomad blockchain network receives the first cryptographic block from the first peer node of the core blockchain network, and a second peer node of the core blockchain network receives the second cryptographic block from the first peer node of the nomad blockchain network.

In another embodiment, a method is described for facilitating assured data exchanges between peer nodes of a core blockchain network and peer nodes in a nomad blockchain network intermittently-connected to the core blockchain network, comprising creating a cryptographically-separated, forward channel and a cryptographically-separated, reverse channel, assigning all of a plurality of orderer nodes of the core blockchain network, at least two peer nodes of the core blockchain network, and a plurality of peer nodes of the nomad blockchain network to the forward channel, assigning all of a plurality of orderer nodes of the nomad blockchain network, at least two peer nodes of the nomad blockchain network and a plurality of peer nodes of the core blockchain network to the reverse channel, wherein when the core blockchain network and the nomad blockchain network are disconnected from each other, publishing a first cryptographic block on the forward channel by a first peer node of the core blockchain network and publishing a second cryptographic block on the reverse channel by a first peer node of the nomad blockchain network, and when the core blockchain network and the nomad blockchain network are re-connected to each other after the first cryptographic block and the second cryptographic block have been published, receiving the first cryptographic block from the first peer node of the core blockchain network by a second peer node of the nomad blockchain network, and receiving the second cryptographic block from the first peer node of the nomad blockchain network by a second peer node of the core blockchain network.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 is a block diagram of one embodiment of a system for facilitating assured data exchanges between peer nodes of a core blockchain network and peer nodes in a nomad blockchain network intermittently-connected to the core blockchain network;

FIG. 2 is a conceptual block diagram of a number of logical, cryptographically-separated private ledger channels for facilitating assured data exchanges between peer nodes of a core blockchain network shown in FIG. 1 and peer nodes in a nomad blockchain network intermittently-connected to the core blockchain network, also shown in FIG. 1;

FIG. 3 is a simplified functional block diagram of one embodiment of any of the peer nodes and orderer nodes as shown in FIG. 1, as well as any of the gateways, computers or systems also shown in FIG. 1; and

FIGS. 4A-4G represent a flow chart illustrating one embodiment of a method, performed by the system shown in FIG. 1 and the various nodes thereof, for facilitating assured data exchanges in a decentralized network among intermittently-connected blockchain networks and/or ledger nodes.

### DETAILED DESCRIPTION

The embodiments herein describe embodiments of a system, method and apparatus for facilitating assured data exchanges in a decentralized network among intermittently-connected ledger nodes and/or networks containing such ledger nodes. In one embodiment, a system is described, where a well-connected, core blockchain network comprising a plurality of orderer and peer nodes is intermittently-coupled to a “nomad” blockchain network of other observer and peer nodes, where the nomad network is intermittently-coupled to the core blockchain network. All of the nodes in the nomad blockchain network are also well-connected to each other.

The embodiments described herein describe a bi-directional exchange of cryptographic blocks between nodes in the core network and nodes in the nomad network even if the nomad network (or some of its peer nodes) occasionally becomes disconnected from the core network, as in the case were nodes in the nomad network might be installed onto a movable asset, such as a vehicle, aircraft, submarine, vessel, etc. In one embodiment, a first, cryptographically-separated “forward” channel is established containing all orderer nodes of the core network, at least two peer nodes of the core network and a plurality of peer nodes of the nomad network. New transactions published on this forward channel by peer nodes in the core network may be replicated to peer nodes in the nomad network when the two networks once again become connected to each other.

Similarly, a reverse channel may also be established, containing all of the orderer nodes of the nomad network, at least two peer nodes of the nomad network and the peer nodes in the core network. In this embodiment, when disconnected from the core network, peer nodes in the nomad network can validate and publish transactions (i.e., blocks) to the peer nodes in the nomad network, and these blocks are made available to peer nodes in the core network once connectivity is re-established between the nomad and core network.

In one embodiment, a second nomad network may be intermittently connected to either the nomad network described above or to the core network. In this embodiment, a second forward channel and a second reverse channel is created for bi-directional block exchange when the second nomad network becomes available to the nomad network or the core network, respectively. Nodes in the second nomad network perform transaction processing and publishing, where peer nodes of the second nomad network receive blocks from the second reverse channel as they are published.

In the case where the second nomad network is intermittently coupled to the nomad network, the nomad network intermittently coupled to the core network may act as a “bridge” network to relay information between the core network and the second nomad network when the second nomad network is connected to the nomad network.

When connected, the core network may share information obtained from its peer nodes and share this information with the peer nodes of the nomad network. This information may comprise command and control data (C2) data from a mission center for sending to a particular nomad node in the nomad network. This information is provided via the forward channel, i.e., cryptographic blocks containing the C2 data, to one or more peer nodes in the nomad network when the nomad network is in communication with the core network. In one embodiment, C2 data may be provided to a nomad network, and chaincode operating within the nomad network disseminates the C2 data to relevant nomad peers by first redacting or aggregating C2 data according to each recipient peer node's security level, mission tasking, distributions, etc.

The nomad network may share information gathered by peer nodes within the nomad network, for example, observational data from ISR (intelligence, surveillance, and reconnaissance) for further analysis. This information may be shared to the core network via the reverse channel or shared with one or more other nomad networks, for example, a Navy battle group providing ISR information to the core network and to a Marine platoon on route to battle. In one embodiment, one of the peer nodes in a Nomad node forwarding ISR data may apply redaction and aggregation rules as described in U.S. patent application Ser. No. 19/169,339, (the “339 application”) assigned to the assignee of the present application and incorporated in its entirety herein, based on the recipient of the reverse channel.

It should be understood that the assured exchange of data records over intermittent connections using ledger channels is completely data agnostic. While above examples are intended to illustrate well-understood use cases, the embodiments of the invention may apply to any system that utilizes ledger channels over intermittent networks to exchange any type of digital information.

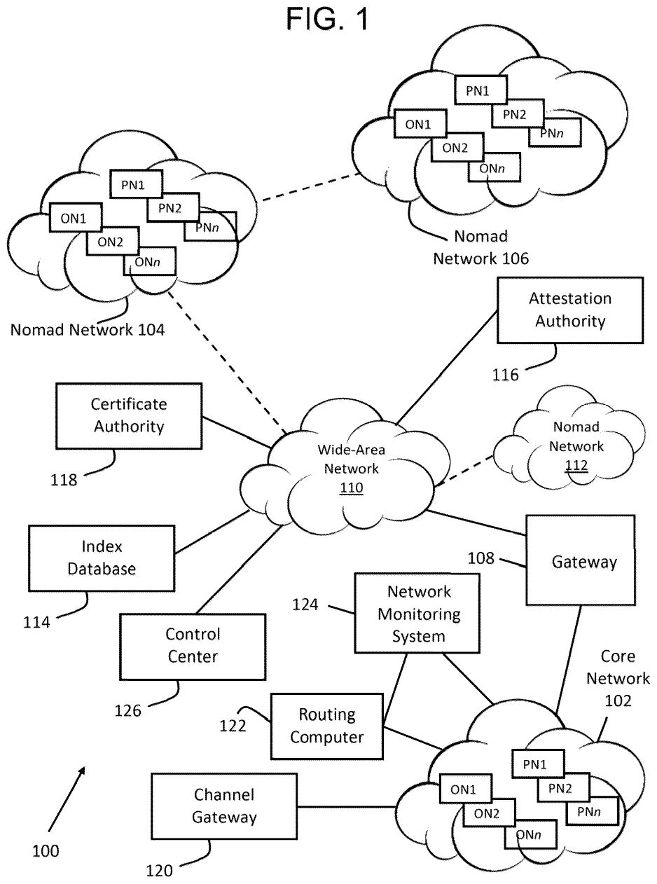

FIG. 1 is a functional block diagram of one embodiment of a system 100 for facilitating assured data exchanges between peer nodes of a core blockchain network and peer nodes in a nomad blockchain network intermittently-connected to the core blockchain network.

FIG. 1 shows core blockchain network 102 that may be intermittently-coupled to peer nodes in nomad blockchain network 104 via wide-area network 110, such as the Internet, a cellular data network, a satellite communication network, etc. While FIG. 1 shows at least two, independent blockchain networks, i.e., core blockchain network 102 and nomad network 104, it should be understood that when these networks are connected to one another, for example, via wide-area network 110, these networks together may form a single blockchain network and be referred to herein as such. The same may be true with respect to other blockchain networks shown in FIG. 1, where any nomad blockchain network may be considered to be part of core blockchain network 102 and/or part one or more other nomad blockchain networks.

Core blockchain network 102 comprises a plurality of orderer nodes “ONs” 1, 2, . . . n, and a plurality of peer nodes “PNs” 1, 2, . . . m. These nodes form a distributed ledger, such as a blockchain network. Typically, the nodes of core network 102 are generally always communicatively coupled to each other, and they may be co-located together inside a building, such as a data center. The number of orderer nodes is typically different than the number of peer nodes, and the number of peer nodes and orderer nodes may range from several to hundreds, thousands or even millions.

It should be understood that the terms core blockchain network, nomad blockchain network and second nomad blockchain network, as used herein, may be used interchangeably with the terms blockchain network, nomad network and second nomad network, respectively. Also, the terms peer, node, peer node, and node, as used herein, may be used interchangeably with each other. Further, the term chaincode and smart contracts may be used interchangeably as well. Additionally, the terms channel, logical channel, ledger, and ledger channel may all be used interchangeably with each other herein.

In one embodiment, a plurality of peer nodes of nomad network 104 are each intermittently connected to peer nodes core network 102. In yet another embodiment, a plurality of nomad peer nodes and nomad orderer nodes are well-connected among each other and form a “nomad cluster”, which, as an entity, may be intermittently connected to core network 102. In yet another embodiment, multiple nomad clusters are intermittently connected to each other, and there is no core network 102 present in the network. In yet another embodiment, two core networks 102 may be intermittently connected to each other and no nomad networks are present. The term “nomad”, in this disclosure, may indicate a node that may become mobile, such as a node affixed to a movable object, such as a person, an animal, a vehicle, an aircraft, a vessel, a train, etc.

The orderer nodes are configured to receive transaction proposals from gateway 108 via wide-area network 110. Transaction proposals may be formatted in accordance with standard blockchain protocols and sent to gateway 108 via client devices (not shown), such as smart phones, computers, etc. Orderer nodes are well-known in the art for ordering a plurality of transaction proposals using consensus techniques, and providing the ordered proposals to a plurality of peer nodes of core network 102 for validation, again, in accordance with well-known techniques.

The peer nodes are configured to maintain local ledger states, interact with the ordering nodes to receive ordered transactions, and validate the ordered transactions via a consensus mechanism, and, once validated, one of the peer nodes is selected to publish a cryptograph block to other peer nodes in core network 102 that are members of a particular channel, and to other peer nodes in nomad network 104 that are members of the same channel when nomad network 104 is communicatively coupled with core network 102. Each cryptographic block may comprise a transactional payload comprising one or more ordered blockchain transaction results, as well as other, typical components of a blockchain transaction, such as an input proposal, endorsements, read-write sets, etc. Each block may additionally comprise metadata related to each transaction result, such as a block number, a previous hash value, smart contract configuration parameters, digital signatures, timestamps, policies for validation and endorsement that apply to the current block, predetermined routing paths, cryptographic signatures generated by the orderer peers and the publishing peer to ensure authenticity and tamper-resistance of the block data, block latencies, transport costs, current route status, peer permissions to modify routing paths, an audit trail, etc. The digital signatures serve as proof of a block's origin and integrity.

Moreover, each block may additionally comprise a link to external metadata, i.e., data associated with each transaction, where the external metadata is modifiable. For example, external metadata may comprise a routing history that is updated each time a peer node within core network 102 or a peer node in an intermittently-coupled network forwards a block to another peer node. Since this external metadata is modifiable, it typically cannot be part of a block itself. Rather, it is typically stored off-chain, for example, in index database 114 coupled to core network 102 via wide-area network 110.

It should be understood that the exact format of each cryptographic block may depend on a specific blockchain implementation and configuration, and does not materially change the concepts described herein.

Core network 102 provides application-specific functionality to be executed by each of the peer nodes as a consensus operation in the context of smart contracts as well-known in the art of blockchain architecture. Smart contract functions may be packaged into Chaincode containers. Each peer node may execute chaincode within its runtime, or, alternatively, execute a smart contract function remotely, such as in the case of one or more peer nodes accessing an external Chaincode-as-a-Service system (not shown).

In one embodiment, a variety of administrative tasks is controlled by a channel gateway 120, such as creating and terminating channels, assigning and un-assigning peer nodes and orderer nodes to channels, deploying channel-specific chaincode to the peers and orderers in the various networks, etc. Channel gateway 120 may store processor-executable instructions, including channel-specific chaincode, for distribution to peers and orderers in the networks shown in FIG. 1. A single channel gateway may manage each network in system 100 or, in other embodiments, two or more channel gateways are assigned to one or more particular networks for independent management.

Channel gateway 120 may store processor-executable instructions associated with a Block Dissemination Protocol (BDP), for providing the various functionality of channel gateway 120, such as enabling the replication and synchronization of cryptographic blocks among distributed peer nodes operating across multiple, logically separated blockchain subnetworks. Specifically, BDP may facilitate the replication of a block among peer nodes in core network 102 of a particular channel and peer nodes in nomad network 104 and/or 106. BDP may be implemented as a smart contract running on each peer node. Replication of a block may comprise determining, by a first peer node PN1, via BDP, that replication to a second peer node PN2 is required, followed by peer node PN1 retrieving a block from a local persistent storage device, transmitting the block to peer node PN2, peer node PN2 validating the authenticity and integrity of the block, and peer node PN2 storing the block on its local persistent storage. It should be noted that either core network 102 or nomad network 104 or 106 can operate independently of each other when replicating a block within a respective network.

In one embodiment, predetermined routing paths are used to disseminate blocks across peer networks. For example, after PN1 has validated and stored a block in its persistent storage, for example, a block store, PN1 may reference a routing path stored within the block (or external to the block) to determine appropriate peers for replication. PN1 may then transmit the block to the designated peers, such as peer node PN2 of core network 102 and peer node PN1 and peer node PN2 of nomad network 104, according to the routing information specified in the routing path. As part of the replication process, PN1 may append its own well-known cryptographic signature to the “signatures” metadata associated with the block, thereby extending a chain of custody and lineage record associated with the block. This routing process supports efficient peer-to-peer dissemination while preventing redundant transmissions. Upon receiving a block, each peer node may repeat the verification process by validating and verifying the block, adding the validated block to a local block store, and, in some embodiments, updating the routing path to reflect successful replication.

Routing paths and associated information, including routing path chaincode in some embodiments, may be provided by a routing computer 122. Routing computer 122 may be coupled to core network 102 directly or via wide-area network 110, for providing routing information to peer nodes in core network 102 as well as nomad networks when connected to a core network. In one embodiment, routing computer 122 is additionally coupled to network monitoring system 124 for receiving network status updates that may affect routing paths, such as connectivity changes, receiving an indication of a threat alert, or other anomalous activity.

In one embodiment, routing computer 122 allows for broadcast replication by providing chaincode to peer nodes for creating a dynamic, real-time routing path for data exchange among the peer nodes of core network 102 and peer nodes of nomad network 104/106. The dynamic routing path may be provided to the peer nodes via a validated cryptographic block stored on a particular logical channel. The block may comprise predefined network guidelines, such as latency thresholds, transport costs, a current route status, etc., allowing a peer node to determine an optimal forwarding path based on the guidelines and actual values stored in the block metadata. The peer node may append its well-known cryptographic signature to the signature metadata before sending the block to a next peer node, maintaining a verifiable chain of custody and lineage record of the block.

In one embodiment, routing computer 122 allows for broadcast replication using a volatile proof routing path for block replication. In high-risk environments, such as tactical edge, adversarial, or highly volatile networks, the metadata in a block may include peer permissions identifying which peer nodes are authorized to modify routing paths, with an audit trail for tracking any changes to the predetermined routing path. This is particularly useful in networks frequently subject to attacks, where specific parameters are defined for safe operation. In this embodiment, routing computer 122 provides chain code to peer nodes which cause each peer node, upon receiving a block, to evaluate the block to determine block integrity and authenticity. If the block is valid, the chain code may cause the peer node to determine an optimal forwarding route based on the current state of the network, i.e., based on known safe peers identified from previously-processed blocks and information contained in a control block, generated during network genesis.

In one embodiment, routing computer 122 may assign a routing path permission level to the peer nodes in system 100, which may include attributes such as read-only, route-suggest, or route-override. Peers with route-override permission can dynamically alter routing paths based on real-time threat detection, connectivity changes, detectability, or other relevant factors, in accordance with chain code provided by routing computer 122. Any modifications to a routing path are typically cryptographically signed and appended to an audit trail embedded in the block metadata. Permission levels may be distributed and verified using predefined control blocks, and may be validated by other peers using known cryptographic keys established during genesis block initialization. This ensures that only trusted peers can influence routing decisions in hostile, denied or otherwise unreliable network environments. In another embodiment, peer permissions for modifying routing paths may be memorialized on a separate ledger channel of a blockchain network, allowing a peer receiving a routing update to validate that the update was generated by a peer authorized in said separate channel. Permissions for peers may be changed dynamically by routing computer 122 based on factors such as a peer's current threat environment or operational state and capabilities.

In one embodiment, a network monitoring system 124 is coupled to core network 102, and in some embodiments, to routing computer 122, comprising processor-executable instructions for attack handling in volatile networks. When a peer detects anomalous activity—such as one or more failed block validations, unexpected or unauthorized route modifications, or signature mismatches, it may declare a “threat detection event”. Upon detection of a threat detection event, the peer may take one or more predetermined actions, such as to transition to a safe mode, restricting block replication to a list of known safe peers defined in a previous control block and/or genesis parameters, and/or notify network monitoring system 124 of the anomalous activity. During this mode, the peer may alter any peer permissions allowing path modifications and only accept blocks from verified sources with established peer permissions. A peer may also generate a local incident report, append it to an audit trail as part of the block metadata, and optionally broadcast a threat alert to other peers and network monitoring system 124, using by creating a new transaction proposal for creation of a new cryptographic block specially configured to alert other peers to the anomaly. Routing computer 122 may be notified of the anomaly via network monitoring system 124, which may then reconfigure routing paths using volatile proof logic, isolating the suspected peer(s) while maintaining overall operation of a network. In another embodiment, peers responsible for authorizing blockchain nodes as valid peers may revoke an authorization of any peer that has generated invalid data or has otherwise deviated from an expected course of action, and/or assign such peer to a different blockchain network (not shown) acting as a quarantine network.

In some embodiments, the functionality of routing computer 122 and network monitoring system 124 may be combined into a single processing unit, such as a computer or a network server.

In one embodiment, BDP includes a mechanism to avoid infinite replication loops via the use of a route history metadata in each block, listing all peers that have forwarded the block.

In one embodiment, BDP defines quorum rules to govern peer recovery within a network. During recovery, a peer may interact with a majority of peers (i.e., a quorum) to validate the authenticity and integrity of a recovered block. A quorum may be determined by a majority of peers, sometimes referred to as “endorsing peers”, who validate the block via consensus before it is considered valid. If a peer recovers its state, it queries its quorum of endorsing peers to obtain the most recent valid block or ledger state. Nomad network 104 may define its quorum as a majority of participating peers who must agree on a block's validity during recovery. A peer may query the quorum within nomad network 104 to confirm the latest block state and synchronize. During peer recovery across core network 102 and nomad blockchain network 104, a quorum consensus between both networks may be required to validate the integrity of a recovered block. A peer may need to confirm that the block is valid according to both networks' quorums before proceeding with recovery. Common quorum definitions include but are not limited to simple majority, greater than 50% majority, two-thirds majority, etc.

In a related embodiment, BDP may include ledger state comparison logic to ensure that the local ledger copy of a peer being recovered is consistent with the network's ledger state during recovery. This process involves comparing Merkle roots and block hashes between the peer's local state and that of its quorum.

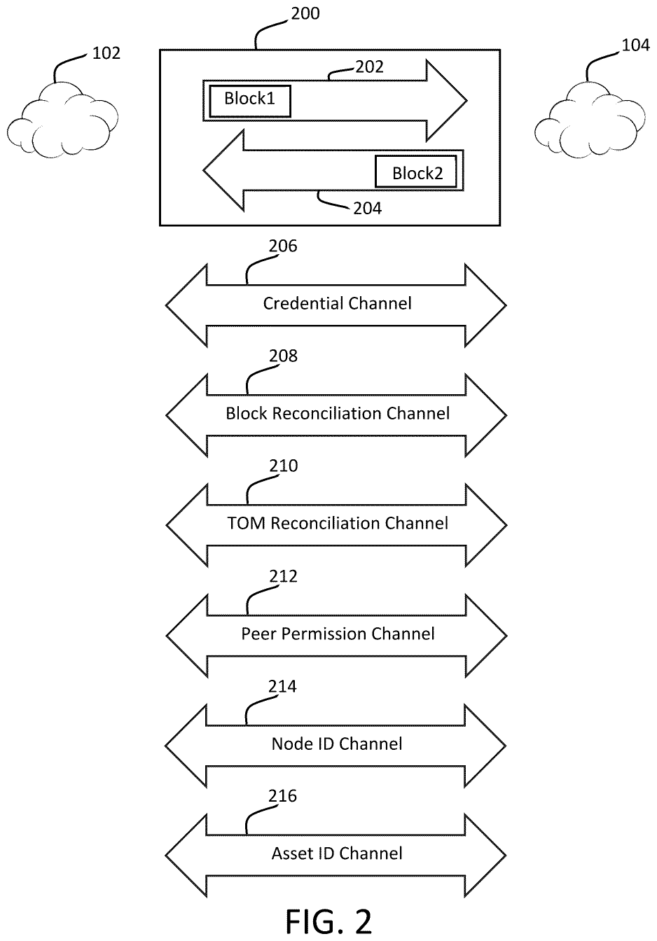

FIG. 2 is a conceptual block diagram of a number of cryptographically-separated, logical ledger channels for facilitating assured data exchanges between peer nodes of a core blockchain network and peer nodes in a nomad blockchain network intermittently-connected to the core blockchain network. Each logical channel represents membership among a plurality of peer nodes and orderer nodes of core network 102 and nomad network 104, where blocks may be published and retrieved only by peer nodes that are a member of a particular channel. “Publishing” a cryptographic block, or simply “block”, on a logical channel, or simply “channel”, means validating a block by a plurality of peer nodes having membership in the same logical channel using a consensus mechanism and, after validation, making the block available to all peer nodes in the channel using one or more replication BDP protocols. Similarly, “retrieving” a validated block on a particular channel means that a peer node having membership in the channel may request a validated block from one or more other peer nodes in the channel, also in accordance with BDP protocols.

Logical channel 200 is shown in FIG. 2 for allowing core network 102 and nomad network 104 to exchange data, i.e., cryptographic blocks published independently of one another while the two networks are disconnected from each another. Channel 200 comprises a forward channel 202 for providing blocks, such as block1 shown in FIG. 2, to peer nodes of core network 102 and to peer nodes of nomad network 104 when the two networks are connected (but does not permit replication of blocks from nomad network 104 to core logic network 102) and a reverse channel 204 for providing blocks, such as block2 shown in FIG. 2, to peer nodes within nomad network 104 and two peer nodes of core network 102 when connected (but does not permit replication of blocks from network 102 to nomad network 104). Block1 and block2 represent cryptographic blocks, such as those generated by typical blockchain networks, and typically comprise metadata associated with each block. In one embodiment, logical channel 200 may comprise only forward channel 202. In another embodiment, logical channel 200 may comprise only reverse channel 204. The particular configuration of logical channel 200 may be based on directional requirements for replication of blocks. It should also be understood that the routing policies of the BDP may differ between forward channel 202 and reverse channel 204 depending on the BDP configuration for either direction at the time of replication.

Forward channel 202 is defined as having two or more peer nodes of core network 102, all orderer nodes of core network 102 and one or more peer nodes of nomad network 104as members. Reverse channel 204 is defined as having two or more peer nodes of nomad network 104, one or more peer nodes of core network 102 and a plurality of orderer nodes of nomad network 104. Both the forward and reverse ledger channels are configured to maintain their membership configuration independently of the connectivity status between core network 102 and nomad network 104.

Peer nodes and orderer nodes belonging to forward channel 202 may issue, validate, and publish transactions as cryptographic blocks even if connectivity to the peer nodes of nomad network 104 is intermittent or unavailable over extended periods of time. Once connectivity is available, any blocks that were published on forward channel 202 during separation may be replicated to the peer nodes in nomad network 104. Similarly, nomad network 104 may issue, validate, and publish transactions as cryptographic blocks on reverse channel 204 even if connectivity to court network 102 is intermittent or unavailable over extended periods of time. Once connectivity is available, any blocks that were published on reverse channel 104 during separation may be replicated to the peer nodes in core network 102.

Using the unidirectional forward channel 202 to maintain a world state of core network 102 and the unidirectional reverse channel 204 to maintain a world state of nomad network 104, embodiments of the present invention improves blockchain network technology by maintaining these world states even when connectivity to some peer nodes is intermittent.

Other channels may also be defined and used by network 102 and network 104, as well as between/among other networks, in addition to channel 200. For example, FIG. 2 shows an optional credential channel 206, an optional block reconciliation channel 208, an optional TOM reconciliation channel 210, an optional peer permission channel 212, an optional node ID channel 214, and an optional asset ID channel 216. Each of these channels will be discussed in more detail later herein. One or more of the aforementioned channels may be configured to support intermittent connectivity between and among networks by defining a forward channel and a reverse channel, similar to how forward channel 202 and reverse channel 204 support intermittent connectivity between core network 102 and nomad network 104.

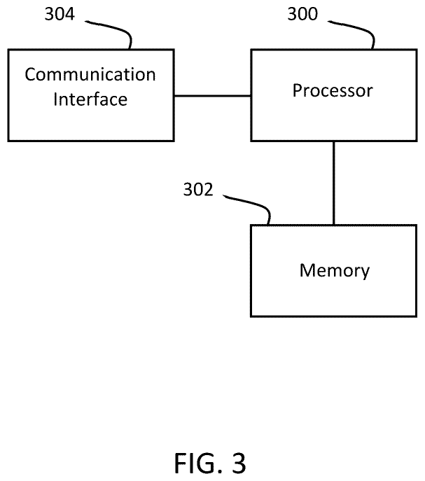

FIG. 3 is a simplified functional block diagram of one embodiment of any of the peer nodes and orderer nodes as shown in FIG. 1, as well as any of the gateways, computers or systems of system 100, each comprising one or more hardware processors 300, one or more non-transitory memories 302, and one or more communication interfaces 304.

Processor 300 is configured to provide general operation of each node, gateway, computers or systems of system 100 by executing respective sets of processor-executable instructions stored in a respective memory 302, for example, executable computer code. Processor 300 typically comprises one or more general or specialized microprocessors, microcontrollers, and/or customized ASICs, System-on-Chips (SoCs), System-in-Packaging (SiP), or the like, and where two or more processors are used, each of the processors, either alone or in combination, may execute one or more of the processor-executable instructions that cause the processor to perform various functions. Processor 300 is selected based on computational speed, cost, power consumption, and/or other factors. When respective processor-executable instructions are loaded into respective memories 302 of each device, processor 300 may become a specialized processor that performs the inventive principles as described herein.

Non-transitory memory 302 is coupled to processor 300 and comprises one or more non-transitory information storage devices, such as static and/or dynamic RAM, ROM, flash memory, or some other type of electronic, optical, or mechanical memory device. Memory 302 may comprise a database for storing cryptographic blocks and blockchain ledgers. Memory 302 is used to store processor-executable instructions for operation of each device, respectively, as well as information relevant to each device. For example, the memory of each peer node may store chaincode comprising a number of smart contracts used in association with validating and publishing (replicating) cryptographic blocks, retrieving cryptographic blocks from other peer nodes, ordering transactions, etc. Additional information stored by memory 302 may comprise block routing information, historical block routing information, block latencies, block transport costs, current and former network states, current route status, peer permissions to modify routing paths, audit trails, identification credentials, etc. It should be understood that in some embodiments, a portion of memory 302 may be embedded into processor 300 and, further, that memory 302 excludes propagating signals.

Communication interface 304 is coupled to processor 300, comprising circuitry for sending and receiving information to/from other nodes/gateways/computers/systems in system 100. Communication interface 304 may comprise wireless circuitry for wirelessly sending and receiving information in a local-area network and/or wide-area network 110, or it may comprise a hardware port and related circuitry to send and receive data via wire, for example, via Ethernet, Serial or USB. All of the above circuitry is well-known in the art.

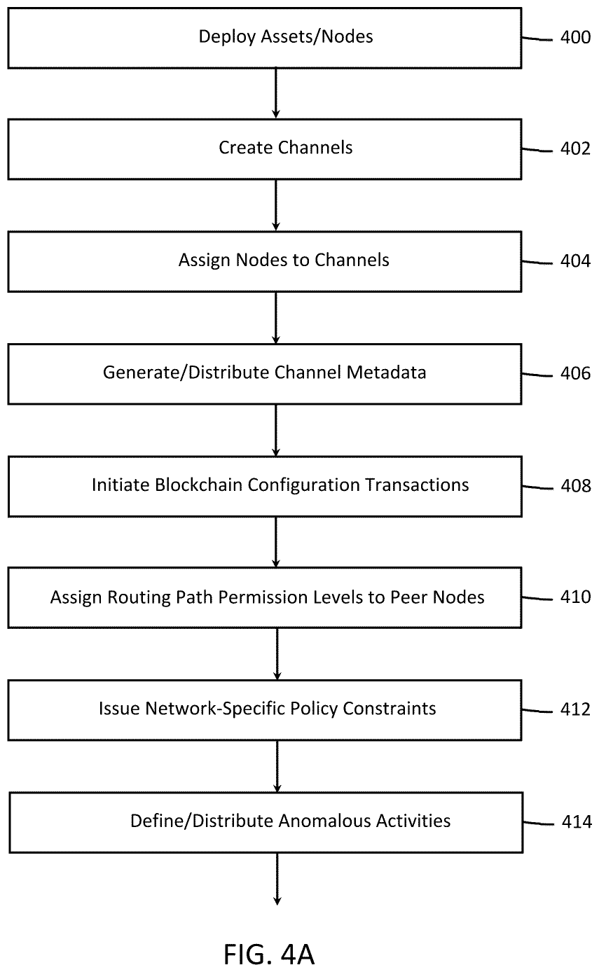

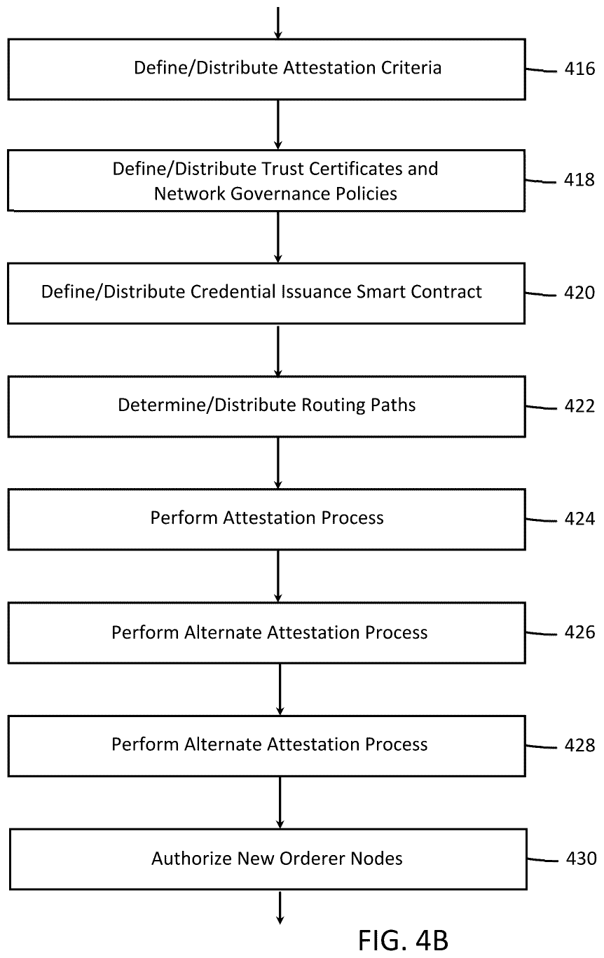

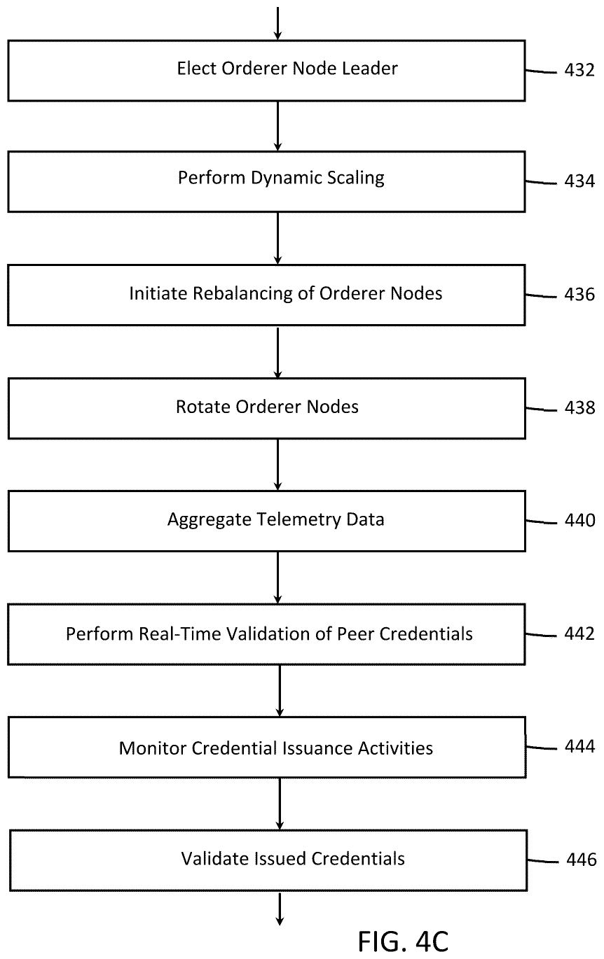

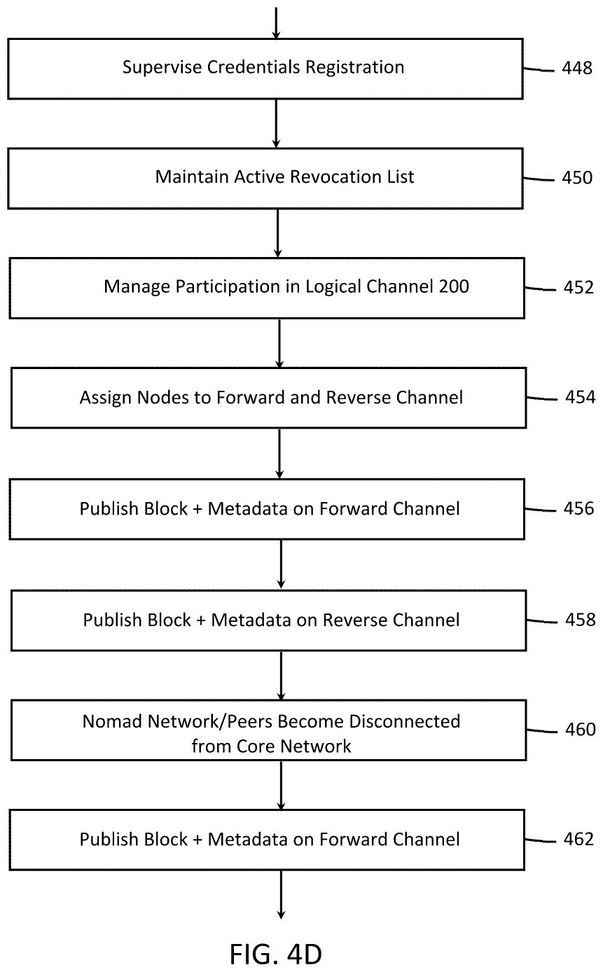

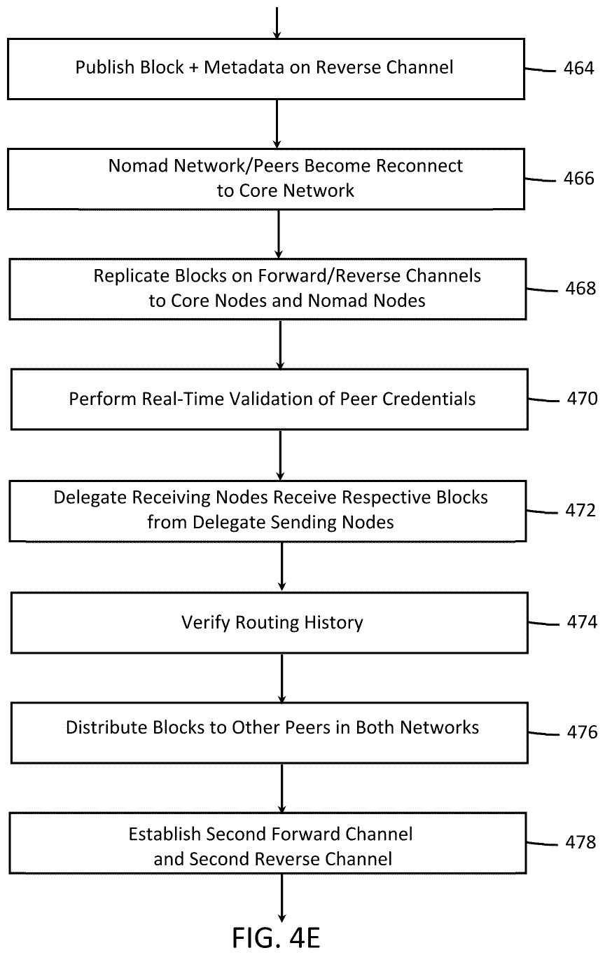

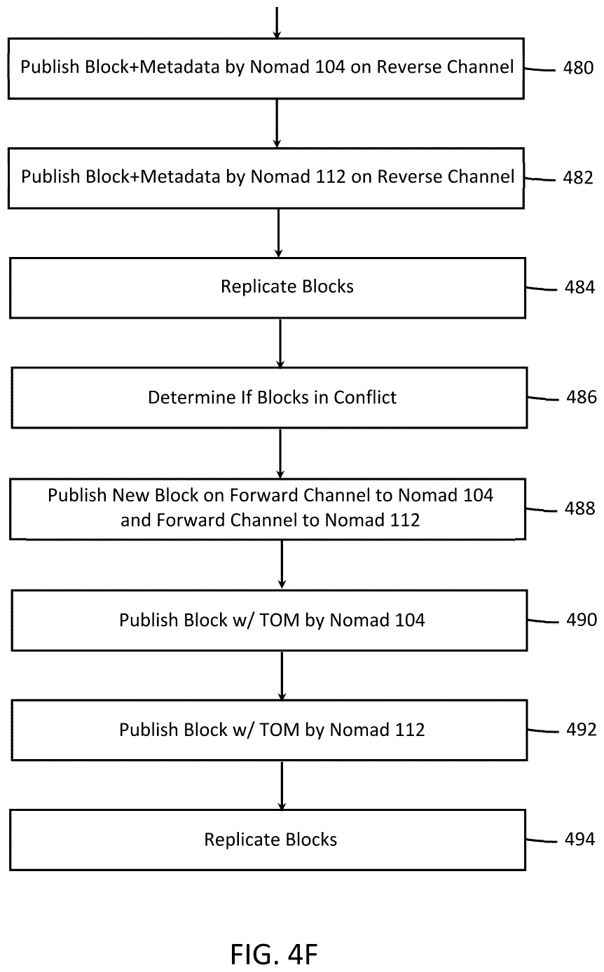

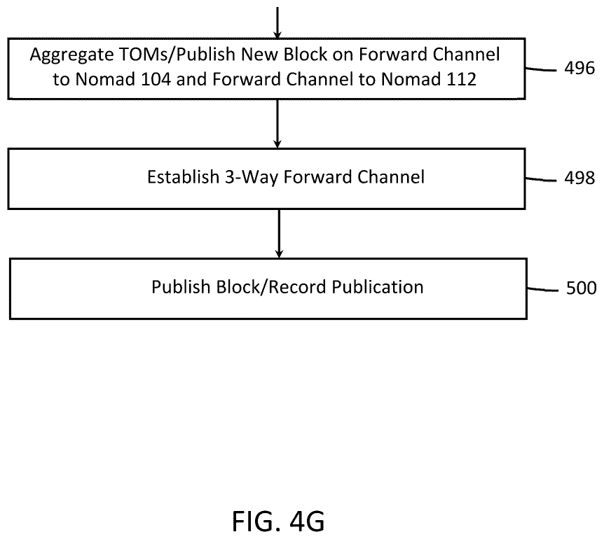

FIGS. 4A-4G represent a flow chart illustrating one embodiment of a method, performed by system 100 and the various nodes thereof, for facilitating assured data exchanges in a decentralized network among intermittently-connected blockchain networks and/or ledger nodes. More specifically, the method describes operations performed by a processor 300 of each of the nodes of system 100, each executing respective processor-executable instructions stored in a respective memory 302, even though processor 300, memory 302 and communication interface 304 may not be explicitly mentioned. It should be understood that in some embodiments, not all of the steps shown in FIGS. 4A-4G are performed, and that the order in which the steps are carried out may be different in other embodiments. It should be further understood that some minor method steps have been omitted for purposes of clarity.

At step 400, assets are deployed across system 100, typically across a wide geographic area, each asset comprising an active node that will be assigned to a particular blockchain network and to one or more logical channels. Some assets may be stationary, for example, a computer in a data center, while others may be mobile, such as people, vehicles, aircraft, vessels, etc. Each asset and node may be assigned a unique node ID or asset ID to uniquely identify each node and asset in system 100. These IDs may be stored in a database, such as index database 114 or published onto a dedicated node ID channel 214 or a dedicated asset ID channel 216, where they may be made available to various nodes in system 100. In a further embodiment, index database may record information pertaining to assets, nodes and entities associated therewith. Records may entail user information such as name, email, organizational identifier, mission or task assignment, departmental membership, etc. Users are typically associated with a system-wide unique identifier. Records may also define credentials and roles that can be associated with users and assets. Records may further identify assets such as field assets, compute resources, mobile devices, etc. In yet a further embodiment, such directory records may be associated with users or equipment that is re-assigned between nomad nodes or nomad networks. In this embodiment, Node ID channel 214 and/or asset ID channel 216 may be used to synchronize the records with core network 102 and/or nomad network 104.

At step 402, cryptographically-separated, logical channels are created by channel gateway 120. Creation of channels does not necessarily mean assignment of peers. Logical channels may comprise one or more unidirectional logical channels 202, 204, credential channels 206, block reconciliation channels 208, TOM reconciliation channels 210, permissions channels 212, node ID channels 214, asset ID channels 216, etc. “Unidirectional” meaning that cryptographic blocks are published by peers in a first blockchain network that are members of a unidirectional channel, where the blocks are accessible by peer nodes in the first blockchain network that are members of the unidirectional channel as well as peer nodes in one or more other blockchain networks that are also members of the unidirectional channel. In the prior art, channels are bidirectional, where all peer nodes of a channel may publish blocks and all peer nodes of the channel may receive blocks once published. Embodiments of the present invention utilize unidirectional channels that are configured to support intermittent connectivity between and among peers of various blockchain networks, and may be created for communication between core network 102 and among any of the blockchain networks shown in FIG. 1, as well as other blockchain networks that may not be shown in FIG. 1. Channels may be formed for use between and among blockchain networks by request, location, network topology, connectivity options, security policy, or other administrative policies.

At step 404, channel gateway 120 assigns nodes in the blockchain networks to one or more of the above channels. Assignment may comprise initializing each node with processor-executable instructions and/or one or more smart contracts for operating as either a peer node, an orderer node, an anchor peer (i.e., a designated peer within a network that acts as a discovery point for other peers in a channel), an origin peer (i.e., a first peer node in a channel to receive and process a transaction), a delegate peer (i.e., peers that execute delegate replication chaincode to facilitate replication of blocks between two or more networks. The delegate replication chaincode is executed by a limited number of nodes in each network acting as initial points of contact between networks. Once a block is received from another network and, after being validated by a delegate peer, the block is forwarded to other peers in the same network. The delegate peers may be designated to solely perform the delegate replication, or contemporaneously perform functions in other ledger channels), etc. Some nodes may be assigned to two or more channels.

At step 406, channel gateway 120 may generate and distribute metadata particular to each channel, such as a listing of participating peer identities, ordering parameters and governance rules.

At step 408, channel gateway 120 may initiate one or more blockchain configuration transactions with the nodes of each network, which are validated and committed via the ordering nodes of each network. In one embodiment, a genesis block is created and published for each channel, which includes initial configuration information such as metadata describing supported chaincodes, certificate trust anchors, block configuration, routing paths, routing history, latency, transport cost, current route status, initial cryptographic keys and audit records for tracking changes to paths. In some embodiments, the genesis block comprises a list of known safe peers for use when an anomalous condition is detected in a network.

At step 410, routing computer 122 may assign routing path permission levels to the peer nodes in any network or channel, and then distribute the permission levels, either to peer nodes directly, or via one or more predefined control blocks. Permission levels may comprise attributes such as read-only, route-suggest, or route-override. Peers with route-override permission may dynamically alter routing paths based on real-time threat detection, connectivity changes, detectability, or other relevant factors. Any modification to a routing path by a permitted peer node may be cryptographically-signed and appended to an audit trail embedded as block metadata. The control block(s) may be validated by other peers in a network using known cryptographic keys established during genesis block initialization. In another embodiment, peer permission levels for modifying routing paths are memorialized in peer permission ledger channel 212, allowing a peer receiving a routing update to validate that the update was generated by a peer authorized in said separate channel. Permissions for peers may be changed dynamically by routing computer 122, based on factors such as a peer's current threat environment or operational state and capabilities, as reported by network monitoring system 124. This ensures that only trusted peers can influence routing decisions in hostile or unreliable network environments.

At step 412, channel gateway 120 may issue network-specific policy constraints such as assigned operation domains, peer roles, or resource access levels to the peers in system 100.

At step 414, one or more anomalous activities may be defined by channel gateway 120 and provided to the peer nodes in system 100. Such activity may comprise the detection of one or more failed block validations, unexpected or unauthorized route modifications, signature mismatches, etc. One or more smart contracts may also be sent to the peer nodes, comprising instructions for a peer node to detect an anomalous activity, and to take specific actions when detected, such as transitioning to safe mode, which causes a peer node to restrict data exchange to a list of known safe peers defined in previous control blocks and genesis parameters, halting routing path modifications and only accepting further blocks from verified sources with established peer permissions. A smart contract of a peer node may instruct the peer node that it has detected anomalous activity and to generate a local incident report comprising details surrounding the anomalous activity (such as date, time, node ID, type of event detected, source node ID, etc.) and append the report to an audit trail metadata of a block. The smart contract may further instruct a peer node that has detected an anomalous activity to broadcast a threat alert to other peers by creating a new transaction proposal and using the peer nodes in the same network to validate and publish the threat on a channel, such as a dedicated network status channel. The smart contract may also instruct a peer node to revoke any peer that has generated invalid data or otherwise deviated from normal, expected peer behavior, from a network, or assign such peers to another blockchain network acting as a quarantine network.

At step 416, attestation criteria are defined and stored in attestation authority 116 for authenticating and validating nodes in system 100. The criteria may comprise one or more of a trust threshold, attestation authority certificates, public keys, device fingerprints, unique hardware identifiers, human-verifiable claims, trusted certificate roots, revocation lists, local ledger state checkpoints, and any other trusted credential information required to verify the authentication and validity of any node in system 100. In some embodiments, an attestation smart contract is defined and distributed to nodes in system 100, the attestation smart contract causing each node to determine its own long-term reliability and quality performance by calculating a “trust score” based on factors such as system resource utilization levels, number of runtime failures, additional latency imposed on blockchain transactions, failures to produce a valid block, behavior that violates a security policy of a network, and other typical performance and stability metrics.

At step 418, certificate authority 118 may create and distribute trust certificates and network governance policies to the nodes of system 100, in some embodiments, by publishing cryptographic blocks containing such information on certificate channel 206. Network governance policies may define operational domains, permission sets, quorum thresholds, and attestation requirements for the nodes in system 100. Enforcement is achieved through real-time credential and transaction validation against active policy states. In some embodiments, specific attributes may be defined for allowing an origin peer to participate in consensus endorsement, such as being in a particular location, being in a particular network subnet, being of a specific hardware version, or supporting specific implementations of a secure private key store.

At step 420, in an embodiment where certificate authority 118 is not used, channel gateway 120 defines a smart contract executed by the nodes of a network for performing credential issuance, validation, and revocation operations. The smart contract validates credential issuance requests against network governance policies, enforces quorum endorsement requirements, and records credential lifecycle events directly onto credential ledger 206. Peer nodes collectively participate in credential decision-making, ensuring that no single administrative entity holds unilateral control. In one embodiment, credential proposals require consensus endorsement from a majority of designated origin peers before acceptance. In another embodiment, a majority of origin peers with specific attributes is specified by the smart contract for consensus endorsement, such as being in a specific location, being in a specific network subnet, being of a specific hardware version, or supporting specific implementations of a secure private key store. Credential revocation equally requires consensus authorization, enhancing network resilience against insider threats, administrative errors, or targeted attacks.

At step 422, routing computer 122 determines routing paths for routing blocks among peer nodes in one or more networks. Each routing path may comprise a chronological listing of peer identifications, such as an assigned unique peer ID or a public key ID of a peer's certificate, indicating how to route each block so that it is replicated to all peers of a particular channel, including peers that may be temporarily disconnected from a network when a routing path is published. In another embodiment, each routing path comprises a cryptographically-verifiable, chronological list of peer identifiers or list of identifiers cryptographically associated with each peer. In another embodiment, each routing path may comprise advanced routing metadata derived from a dynamic ad-hoc routing mechanism, wherein each peer performs the function of a routing node as disclosed in U.S. application Ser. No. 17/467,193 entitled DISTRIBUTED LEDGER-BASED AD-HOC SYSTEM, APPARATUS AND METHOD, assigned to the assignee of the present disclosure and incorporated by reference in its entirety herein. Specifically, the routing metadata may incorporate constraint-based route selection and validation mechanisms as further described in '193 application.

At step 424, a multi-phase attestation process may be performed by peer nodes of a network via an on-ledger smart contract mechanism (e.g., chaincode), wherein the attestation workflow is fully executed within a blockchain network. This ensures that peer enrollment, verification and trust establishment are performed in a deterministic, auditable and consensus-based process.

In one embodiment, attestation authority 116 performs a multi-phase attestation process wherein a joining peer of core network 102 or nomad network 104, when connected to core network 102, submits a credential request to attestation authority 116. Attestation authority 116 comprises a computer or computer server comprising a processor, a memory for storing processor-executable instructions and a communication interface, wherein the processor executes the processor-executable instructions stored in the memory to perform the attestation processes herein.

In response to receiving the credential request from the joining peer, attestation authority 116 may issue a challenge requiring cryptographic proof of identity, such as signing a nonce using the peer's private key. Upon successful validation of the signature, attestation authority 116 records the attestation event on credential channel 206 and issues a signed membership token for permission to join a particular channel. In some implementations, quorum endorsement from existing trusted peers may be required prior to finalization. In another embodiment, the attestation record includes a timestamp, trust score, and audit reference for future validation. It should be understood that the described process supports any credential type or key material that supports cryptographic identification and authentication of the joining peer and attestation authority 116.

At step 426, in another attestation embodiment, an initiating peer transmits an Attestation Proposal to a quorum of pre-established, trusted network peers. Each receiving peer validates the proposal against one or more of the following: trusted certificate roots, revocation lists, and local ledger state checkpoints, and any other trusted credential information required to verify the validity of the proposal. Upon successful validation, each peer returns a cryptographically signed Attestation Endorsement. The initiating peer may aggregate these endorsements into a unified Attestation Record. In one embodiment, this Attestation Record is published onto credential channel 206 for memorialization and future verification.

At step 428, in another attestation embodiment, issuance and maintenance of certificate-based credentials is performed by peer nodes in a channel or network. In this embodiment, credential issuance, validation, and revocation operations are performed by a consensus-driven smart contract executed by the peer nodes of a network. Credential management chaincode is distributed to the peers, and each peer validates credential issuance requests against network governance policies, enforces quorum endorsement requirements, and records credential lifecycle events onto credential channel 206. The Peer nodes collectively participate in credential decision-making, ensuring that no single administrative entity holds unilateral control. In one embodiment, credential proposals require consensus endorsement from a majority of designated origin peers before acceptance. In another embodiment, a majority of origin peers with specific attributes is required for consensus endorsement, such as being in a specific location, being in a specific network subnet, being of a specific hardware version, or supporting specific implementations of a secure private key store. Credential revocation may equally require consensus authorization, enhancing network resilience against insider threats, administrative errors, or targeted attacks.

At step 430, channel gateway 122 may authorize the addition of new orderer nodes to a network. This includes validation orderer credentials, assigning consensus roles and updating ordering service metadata across the network. In one embodiment, certificate issuance and enrollment operations for orderer nodes is performed by certificate authority 118. In another embodiment, certificate issuance is performed by peer nodes of a network in accordance with credential management chaincode.

At step 432, channel gateway 122 may coordinate elections of a leader among orderer nodes responsible for managing block assembly and dissemination in a particular network. Leadership selection may follow pre-defined policy criteria such as node reputation, uptime statistics or cryptographic randomness verifiable on a ledger. Election outcomes may be recorded immutably on a ledger channel associated with the network for auditability and operational transparency

In step 434, channel gateway 122 may oversee dynamic scaling operations, including the addition or removal of orderer nodes based on network load, transactions volume, or administrative actions. In a typical implementation, the scaling operations are automatically triggered based on monitored telemetry thresholds or manually initiated by administrative consensus via control center 126.

In step 436, channel gateway 122 may initiate rebalancing operations to redistribute ordering responsibilities among remaining operational orderers upon detection of an orderer failure,. In a typical implementation, channel gateway may rebalance a network by adding new orderers to keep a minimum set of healthy orderers as set by a network policy of each network.

In step 438, channel gateway 122 may cause periodic or emergency rotation of orderer node credentials and cryptographic keys. Key rotation events may be triggered based on time, use-based (i.e. number of times or accumulative data size the key was applied to) policies, detected anomalies, cryptographic strength updates, or administrative key rollover procedures or administrative decisions to enhance network security. In one embodiment, credential operations as described in this step may be executed by certificate authority 118. In another embodiment, credential operations as described in this step may be executed through a distributed, certificate management chaincode executed by origin peers, wherein credential decisions may be collectively validated and recorded on credential channel 206 to ensure decentralized trust and operational resilience.

In step 440, channel gateway 122 may aggregate telemetry data from all participating orderer nodes, including heartbeat signals, consensus latency, block creation rates, and error metrics. In a typical implementation, orderer health reports may be generated from such aggregated telemetry data and used to take actions as described above in steps 434, 436 and 438.

In step 442, at any point during network participation, peers may present their credentials during any authenticated operation. Receiving peers, such as an origin peer, are authorized to perform real-time validation of the presented credentials. This validation process typically includes checks for expiration timestamps, revocation status recorded in credential channel 206, and compliance with applicable policy constraints such as assigned operation domain, peer roles, or resource access levels. In one embodiment, credential validation may include trust scoring logic, where a dynamic score is computed based on a combination of metadata attributes. In a typical implementation, metadata attributes include credential age, issuer reputation, prior operational records, and observed anomalies. The score could be used to determine if the presenting peer meets the allowed threshold for network participation. If the trust score falls below the defined policy minimum, a peer 200 may be denied access to the network, allowed to participate with limited operational privileges pending review, or placed into a quarantine state under observation by personal at central control 126. In one embodiment, such decisions are recorded immutably on credential channel 206 and distributed to the participating peers for transparency and policy consistency.

In step 444, credential issuance activities may be monitored by the peers of any network, channel gateway 122, or certificate authority 118. The monitoring activity can verify that issuance requests from peers align with administrative enrollment policies and authorized identity frameworks before permitting credential generation. In one embodiment, credential operations as described in this step may be executed by certificate authority 118. In another embodiment, credential operations as described in this step may be executed through a distributed, certificate management chaincode from channel gateway 122, which may be executed by origin peers in a network, wherein credential decisions may be collectively validated and recorded on credential ledger 206 to ensure decentralized trust and operational resilience.

In step 446, issued credentials may be validated to ensure that each contains required metadata attributes, such as role assignments, operational domains, or device fingerprints. Credentials missing mandatory attributes may be flagged, revoked, or prevented from activation. In one embodiment, the attributes are as disclosed in the '339 application. In another embodiment, credential operations as described in this step may be executed by a certificate authority 118. In another embodiment, credential operations as described in this step may be executed through a distributed, certificate management chaincode from channel gateway 122, which may be executed by origin peers in a network, wherein credential decisions may be collectively validated and recorded on credential ledger 206 to ensure decentralized trust and operational resilience.

In step 448, the secure registration of credentials into credential channel 206 may be supervised by performing additional cryptographic verification of signatures and fingerprint consistency before final acceptance. In one embodiment, credential operations as described in this step may be executed by certificate authority 118. In another embodiment, credential operations as described in this step may be executed through a distributed, certificate management chaincode from channel gateway 122, which may be executed by origin peers in a network, wherein credential decisions may be collectively validated and recorded on credential ledger 206 to ensure decentralized trust and operational resilience.

In step 450, an active revocation list may be maintained, ensuring that expired, compromised, or administratively withdrawn credentials are flagged and distributed across a network. Peers may use this list during real-time credential validation steps. In one embodiment, credential operations as described in this step may be executed by certificate authority 118. In another embodiment, credential operations as described in this step may be executed through a distributed, certificate management chaincode from channel gateway 122, which may be executed by origin peers in a network, wherein credential decisions may be collectively validated and recorded on credential ledger 206 to ensure decentralized trust and operational resilience. In yet another embodiment, the active revocation list is maintained in the form of a certificate revocation list (CRL), well-known in the art. In another embodiment, the active revocation list is represented by a current state of a revocation channel of core network 102.

In step 452, participation in logical channel 200 by peers in core network 102 and nomad network 104 are managed. In a typical implementation, when a new logical channel 200 is created, a genesis block is generated, and a peer in core network 102 validates the configuration against the peer local trust score. If validation is successful, the peer joins logical channel 200 and initializes the required chaincode environments. In one embodiment, the process of joining or leaving a channel is autonomously enforced by peer nodes and origin peers of core network 102, subject to dynamic role evaluations of the joining peer or trust score evaluation. In one embodiment, operations as described in this step may be executed by channel gateway 120.

At step 454, typically while core network 102 and nomad network 104 are in communication with each other, channel gateway 120 assigns all of the orderer nodes of core network 102, at least two peer nodes of core network 102, and a plurality of peer nodes of nomad network 104 to forward channel 202. Channel gateway 120 further assigns all of the orderer nodes of nomad network 104, at least two peer nodes of nomad network 104 and a plurality of peer nodes of core network 102 to reverse channel 204.

At step 456, core network 102 may publish a cryptographic block on forward channel 200 upon the occurrence of a predefined event, such as receiving C2 data from control center 126. The block comprises the C2 data and related metadata, such as a channel identifier indicating that the block is intended for nodes of a particular channel, in this case, forward channel 200. The metadata could also comprise a predetermined routing path, a routing history, a latency in transporting the block from peer to peer, a transport cost, a current route status, cryptographic keys, audit records for tracking changes to the routing path, and/or other data as described previously herein.

Publication on forward channel 200 effectively causes the block to be replicated to all other peer nodes, in one embodiment, by each peer node forwarding the block to a next peer node as listed in each peer's routing path. In another embodiment, the block is broadcasted to any other peer node having membership in forward channel 200 and in range of the broadcasting peer. When core network 102 is in communication with nomad network 104, the block is provided not only to peers in core network 102, but also to peers in nomad network 104 that members of forward channel 200. As a result, all of the peer nodes of forward channel 202 have received the block and all of these peer nodes contain the same, updated world state of forward channel 202.

At step 458, nomad network 104 may publish a cryptographic block on reverse channel 202 upon the occurrence of a predefined event, such as receiving data collected from one or more assets deployed in system 100, such as data from an aircraft in the form of location, speed, heading, status, etc., data from a digital camera such as a video stream, status updates, or virtually any kind of digital information sensed or created by peers in nomad network 104. The data is typically provided to nomad network 104 in the form of a blockchain proposal. After validating and authenticating the blockchain proposal, a block is produced by one of the peer nodes of nomad network 104 and published on reverse channel 202. The block comprises the received data and related metadata, as previously described.

Publication on reverse channel 200 effectively causes the block to be replicated to any peer nodes that is a member of reverse channel 200 in nomad network 104, as well as any peer nodes belonging to reverse channel 200 in core network 102 when core network 102 is communicatively coupled to nomad network 104. As a result, all of the peer nodes of reverse channel 200 have received the block and all of these peer nodes contain the same, updated world state of reverse channel 204.

At step 460, nomad network 104, or at least some of the peer nodes of nomad network 104 become communicatively disconnected from core network 102 and/or wide-area network 110. This may occur, for example, as nomad peers located on an aircraft carrier leaves port, nomad peers each located on a particular helicopter in a squadron of helicopters being dispatched to a target location, nomad peers in an automobile when the automobile drives out of range of core network 102 or wide-area network 110, etc.

At step 462, another cryptographic block is published onto forward channel 200 by one of the peers of core network 102 when nomad network 104 is not in communication with core network 102. The block is replicated and distributed to all of the peers in core network 102 that are members of forward channel 202. As a result of nomad network 104 not in communication with core network 102, none of the nomad peers in nomad network 104 receives the block.

At step 464, another cryptographic block is published onto reverse channel 202 by one of the peers of nomad network 104 when nomad network 104 is not in communication with core network 102. The block is replicated and distributed to all of the peers in nomad network 104 that are members of reverse channel 202. As a result of nomad network 104 not in communication with core network 102, none of the core peers in core network 102 receives the block.

At step 466, nomad network 104, or the peer nodes that were disconnected from core network 102, become reconnected with core network 102, for example, when a movable asset moves back within range of core network 102 and/or wide-area network 110. Detection that nomad network 104 has reconnected with core network 102 is performed by one or more predetermined peer nodes of either core network 102 and/or nomad network 104, as is well-known in the art.

At step 468, in response to determining that nomad network 104 is now back in communication with core network 102, the block published on forward channel 202 is replicated to all peer nodes of nomad network 104 belonging to forward channel 202, and the block published on reverse channel 204 is replicated to all peer nodes of core network 104 belonging to reverse channel 204, as follows.

At step 470, Delegate Replication Chaincode may be defined and distributed to all peers in local area network 102 and nomad network 104 when both networks are connected. The delegate replication chain code causes one or more delegate peer nodes of core network 102 to replicate the block on forward channel 202 to respective delegate peers in nomad network 104. Similarly, the delegate replication chain code causes one of the delegate peer nodes of nomad network 104 to replicate the block on reverse channel 204 to respective delegate peers in core network 102.

In one embodiment, each, respective delegate peer may forward a respective block based on a) a predetermined routing path stored as block metadata of the current block being replicated or stored by the sending delegate node, b) a modified routing path when a respective delegate peer is authorized to modify the routing path or c) determine a routing path in real-time, all as previously discussed herein. In another embodiment, each respective block may be broadcast to any peers within range of a sending delegate peer, as well known in the art.

At step 472, a receiving delegate node of core network 102 and a receiving delegate node of nomad network 104 receives a respective block from the respective sending delegate nodes.

At step 474, each of the receiving delegate nodes may verify each's respective received block was previously forwarded by valid nodes of either core network 102 or nomad network 104, respectively, by checking a routing history stored as block metadata in each respective, received block. If an error is detected, a respective receiving delegate node may issue an incident report, identifying a peer that was not a valid peer of either channel, and appends it to the audit trail of the current block, and/or optionally broadcasting a threat alert to other peers via a new blockchain proposal.

At step 476, each respective block of forward channel 202 and reverse channel 204 are then forwarded to other peer nodes of either local area network 102 or nomad network 104, respectively, using the above block-forwarding techniques.

At step 478, channel gateway 120 may establish a second forward channel and a second reverse channel for use by peers in core network 102 and nomad network 112.

At step 480, nomad network 104 may publish a cryptographic block and associated metadata on reverse channel 204. The metadata may reference a particular asset in system 100, such as a particular aircraft, and particular data regarding the aircraft, such as its current location, for example, or a particular human- or machine-generated data regarding the aircraft. The location information may have been gathered by one of the peer nodes in nomad network 112 by obtaining GPS coordinates of the aircraft.

At step 482, nomad network 112 may publish a cryptographic block and associated metadata on the second reverse channel. The metadata may reference the same aircraft and the location information of the aircraft as reported to a peer node in nomad network 112 from a ground radar. In this example, the location of the aircraft reported by the ground radar does not match the location reported by GPS.

At step 484, the block published by nomad network 104 may be replicated to peer nodes of core network 102 when nomad network 104 is in communication with core network 102. Similarly, the block published by nomad network 112 may be replicated to peer nodes of core network 102 when nomad network 112 is in communication with core network 102. The blocks may be received by the peers of core network 102 nearly simultaneously, such as when nomad network 104 and nomad network 112 are in communication with core network 102 as the blocks are being published, or received at different times, if one of the nomad networks become connected to core network 102 at a different time.

At step 486, delegate peers of core network 102 may execute reconciliation chaincode when these peers detect two or more blocks related to the same entity where at least some of the metadata in the blocks conflict with each other. The reconciliation chaincode may cause each delegate peer in core network 102 to evaluate blocks received from the nomad networks to determine whether any of the blocks contain metadata associated with a particular entity, where the metadata is in conflict. For example, the metadata of the block published by nomad network 104 indicates that the aircraft is at a particular location while the metadata of the block published by nomad network 112 indicates that the same aircraft is at a different location. The reconciliation chaincode may also evaluate blocks based on associated time metadata, for example, a date and time when the metadata of each block was determined, or a quality score of the sensor system used to generate the metadata. In the present example, if the location of the aircraft as determined by GPS and the radar system were determined within a predetermined time of each other, for example, one minute, the reconciliation chaincode may cause each delegate peer to perform an action, as described below. If a significant, predetermined time gap exists between the metadata of each block, such as five minutes or more, the reconciliation chaincode may determine that the conflict is a result of the time difference. Alternatively, if the location of the aircraft as determined by GPS and the radar system were determined at the same time, the reconciliation chaincode may determine that the conflict is a result of different sensing technologies, and will select the direct, higher quality, GPS measurement over the indirect, lower quality, radar measurement of the aircraft's location. The reconciliation chaincode may cause each delegate peer to determine whether conflicts exist using procedures such as first-wins, latest-wins, highest-quality-level wins, highest-security-level-wins, time-filtering, geo-filtering, machine-learning based filtering, or similar methods, including manual reconciliation via an administrative action.

At step 488, when the reconciliation chaincode determines that a conflict exists between or among two or more blocks associated with the same entity and, in some embodiments, within a predetermined time from when the data in each block was recorded, the reconciliation chaincode may cause the delegate peers in core network 102 to publish a single, new version of blocks on forward channel 202 for distribution to peer nodes of nomad network 104 and publish the same block on the second forward channel created for use by the peer nodes in nomad network 112.

At step 490, continuing with the example above, nomad network 104 may publish a cryptographic block containing a TOM (as described in the '339 application) and associated metadata on reverse channel 204. The metadata may reference a particular asset in system 100 and particular data regarding the asset.

At step 492, nomad network 112 may publish a cryptographic block and associated metadata on the second reverse channel. The metadata may reference the same asset as reported in the block produced by nomad network 104.

At step 494, the block published by nomad network 104 may be replicated to peer nodes of core network 102 when nomad network 104 is in communication with core network 102. Similarly, the block published by nomad network 112 may be replicated to peer nodes of core network 102 when nomad network 112 is in communication with core network 102. The blocks may be received by the peers of core network 102 nearly simultaneously, such as when nomad network 104 and nomad network 112 are in communication with core network 102 as the blocks are being published, or received at different times, if one of the nomad networks become connected to core network 102 at a different time.

At step 496, delegate peers of core network 102 may execute TOM reconciliation chaincode when these peers detect two or more blocks, each comprising a TOM, each TOM referencing the same asset and, in some cases, when the data within each TOM was recorded within a predetermined time from each other. The TOM reconciliation chaincode may cause each delegate peer in core network 102 to aggregate the TOMs from the blocks received from the nomad networks, as described in the '339 application. The resulting TOM may be published in a new block on forward channel 202 for distribution to peer nodes of nomad network 104 and publish the same or similar block on the second forward channel created for use by the peer nodes in nomad network 112.

At step 498, in one embodiment, a separate, 3-way, forward channel may be defined across core network 102, nomad network 104 and nomad network 112. Any reconciled blocks aggregated TOMs may be published onto this channel as a reconciled source of truth for all blockchain networks participating in this channel.

At step 500, in one embodiment, when a block containing a TOM is published onto the 3-way forward channel, as described above, a record of the publication may be provided to index database 114 by only the publishing blockchain network. For example, if a block containing a TOM is published by core network 102, a corresponding record of this publication may be provided to index database 114 by core network 102. Once the block is replicated to a delegate peer of nomad network 104, upon successful validation, the delegate peer may store the block on its local persistent ledger storage, and provide a corresponding record of the receipt and validation to either index database 114, or another index database associated with nomad network 104. In one embodiment, any peer in nomad network 104 may perform this operation based on, for example, a first to receive, round-robin, or similar algorithms. When a block containing a TOM is published by nomad network 104, a peer node in core network 102 may perform the same process.

It should be understood that the selection of a peer node to establish a forward channel and a reverse channel to a particular network is not limited to a single peer or a static selection. Multiple peers may be selected for redundancy, and assignment of a peer node managing the forward and reverse channels may be dynamic based on network conditions, cluster topologies, and node capabilities. Furthermore, separate nodes may be selected to manage the forward versus reverse channels. Criteria for selecting one or more nodes to manage the forward and reverse channels may vary significantly between deployments and applications. Some factors may include node connectivity, compute resources, node security level, trustworthiness, node geolocation, node association with a specific platform (e.g. a forward operating base versus a vessel, or a drone), its observability, its exposure to adversarial activities, etc.

Although specific advantages have been enumerated above, various embodiments may include some, none, or all of the enumerated advantages. Other technical advantages may become readily apparent to one of ordinary skill in the art after review of the foregoing figures and description.

It should be understood at the outset that, although exemplary embodiments are illustrated in the figures and described above, the principles of the present disclosure may be implemented using any number of techniques, whether currently known or not. The present disclosure should in no way be limited to the exemplary implementations and techniques illustrated in the drawings and described above.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. The article “a” means “one or more”.

In many places in this document, actions (e.g., functionality) are performed by one or more processors executing processor-executable instructions (i.e., software, firmware). This is done for ease of description; it should be understood that, whenever it is described in this document that software performs any action, the action is in actuality performed by underlying hardware elements (such as a processor and a memory device) according to the instructions that comprise the software. Such functionality may, in some embodiments, be provided in the form of firmware and/or hardware implementations.

The elements described in this document include actions, features, components, items, attributes, and other terms. Whenever it is described in this document that a given element is present in “some embodiments,” “various embodiments,” “certain embodiments,” “certain example embodiments, “some example embodiments,” “an exemplary embodiment,” “an example,” “an instance,” “an example instance,” or whenever any other similar language is used, it should be understood that the given element is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments.

Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an”, and “the” should be read as meaning “at least one,” “one or more,” or the like; the term “example”, which may be used interchangeably with the term embodiment, is used to provide examples of the subject matter under discussion, not an exhaustive or limiting list thereof; the terms “comprise” and “include” (and other conjugations and other variations thereof) specify the presence of the associated listed elements but do not preclude the presence or addition of one or more other elements; and if an element is described as “optional,” such description should not be understood to indicate that other elements, not so described, are required.

As used herein, the term “non-transitory computer-readable storage medium” includes a register, a cache memory, a ROM, a semiconductor memory device (such as D-RAM, S-RAM, or other RAM), a magnetic medium such as a flash memory, a hard disk, a magneto-optical medium, an optical medium such as a CD-ROM, a DVD, or Blu-Ray Disc, or other types of volatile or non-volatile storage devices for non-transitory electronic data storage. The term “non-transitory computer-readable storage medium” does not include a transitory, propagating electromagnetic signal.

The claims are not intended to invoke means-plus-function construction/interpretation unless they expressly use the phrase “means for” or “step for.” Claim elements intended to be construed/interpreted as means-plus-function language, if any, will expressly manifest that intention by reciting the phrase “means for” or “step for”; the foregoing applies to claim elements in all types of claims (method claims, apparatus claims, or claims of other types) and, for the avoidance of doubt, also applies to claim elements that are nested within method claims. Consistent with the preceding sentence, no claim element (in any claim of any type) should be construed/interpreted using means plus function construction/interpretation unless the claim element is expressly recited using the phrase “means for” or “step for.”

Whenever it is stated herein that a hardware element (e.g., a processor, a network interface, a display interface, a user input adapter, a memory device, or other hardware element), or combination of hardware elements, is “configured to” perform some action, it should be understood that such language specifies a physical state of configuration of the hardware element(s) and not mere intended use or capability of the hardware element(s). The physical state of configuration of the hardware elements(s) fundamentally ties the action(s) recited following the “configured to” phrase to the physical characteristics of the hardware element(s) recited before the “configured to” phrase. In some embodiments, the physical state of configuration of the hardware elements may be realized as an application specific integrated circuit (ASIC) that includes one or more electronic circuits arranged to perform the action, or a field programmable gate array (FPGA) that includes programmable electronic logic circuits that are arranged in series or parallel to perform the action in accordance with one or more instructions (e.g., via a configuration file for the FPGA). In some embodiments, the physical state of configuration of the hardware element may be specified through storing (e.g., in a memory device) program code (e.g., instructions in the form of firmware, software, etc.) that, when executed by a hardware processor, causes the hardware elements (e.g., by configuration of registers, memory, etc.) to perform the actions in accordance with the program code.

A hardware element (or elements) can therefore be understood to be configured to perform an action even when the specified hardware element(s) is/are not currently performing the action or is not operational (e.g., is not on, powered, being used, or the like). Consistent with the preceding, the phrase “configured to” in claims should not be construed/interpreted, in any claim type (method claims, apparatus claims, or claims of other types), as being a means plus function; this includes claim elements (such as hardware elements) that are nested in method claims.

Although process steps, algorithms, or the like, may be described or claimed in a particular sequential order, such processes may be configured to work in different orders. In other words, any sequence or order of steps that may be explicitly described or claimed in this document does not necessarily indicate a requirement that the steps be performed in that order; rather, the steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

Although various embodiments have been shown and described in detail, the claims are not limited to any particular embodiment or example. None of the above description should be read as implying that any particular element, step, range, or function is essential. All structural and functional equivalents to the elements of the above-described embodiments that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, element, component, or step in this document is intended to be dedicated to the public.

What is claimed is:

1. A system, configured to facilitating assured data exchanges in a decentralized network among intermittently-connected ledger nodes, comprising:
a plurality of peer nodes of a core blockchain network;
a plurality of orderer nodes of the core blockchain network;
a plurality of peer nodes of a nomad blockchain network;
a plurality of orderer nodes of the nomad blockchain network;
a channel gateway for creating a cryptographically-separated, forward logical channel and a cryptographically-separated, reverse logical channel, and for assigning all of the plurality of orderer nodes of the core blockchain network, at least two peer nodes of the core blockchain network, and the plurality of peer nodes of the nomad blockchain network to the forward logical channel and for assigning all of the orderer nodes of the nomad blockchain network at least two peer nodes of the nomad blockchain network and the plurality of peer nodes of the core blockchain network to the reverse logical channel;
wherein:
when the core blockchain network and the nomad blockchain network are disconnected from each other, a first peer node of the core blockchain network publishes a first cryptographic block on the forward channel and a first peer node of the nomad blockchain network publishes a second cryptographic block on the reverse channel; and
when the core blockchain network and the nomad blockchain network are re-connected to each other after the first cryptographic block and the second cryptographic block have been published, a second peer node of the nomad blockchain network receives the first cryptographic block from the first peer node of the core blockchain network, and a second peer node of the core blockchain network receives the second cryptographic block from the first peer node of the nomad blockchain network.

2. The system of claim 1, further comprising:
a gateway for receiving a plurality of transaction proposals from one or more client devices coupled to the gateway, and for providing the plurality of transaction proposals to all of the ordering peers in the core blockchain network;
wherein the ordering peers in the core blockchain network order the plurality of transactions to produce an ordered plurality of transactions;
wherein the at least two peer nodes of the core blockchain network are configured to validate the ordered plurality of transactions and, when validated;
a first peer node of the core blockchain network is configured to publish the first cryptographic block on the forward channel, thus making the first cryptographic block available to any peer node of the core blockchain network assigned to the forward channel; and
after the core blockchain network and the nomad blockchain network have re-connected to each other, a second peer node of the core blockchain network provides the first cryptographic block to at least one of the plurality of peer nodes of the nomad blockchain network for replication to the other peer nodes of the nomad blockchain network.

3. The system of claim 1, wherein first metadata is associated with the first cryptographic block and second metadata is associated with the second cryptographic block, wherein a first peer node of the core blockchain network is configured to:
receive the second block from a first peer node of the nomad blockchain network after the core blockchain network and the nomad blockchain network have re-connected with each other; and
verify an authenticity of the second block by:
validating a cryptographic signature contained within the second cryptographic block; and
validating the second metadata, the second metadata comprising a route history, the route history comprising a listing of any peer nodes of the nomad blockchain network that forwarded the second block across the nomad blockchain network and to the first peer node of the core blockchain network, wherein validating the second metadata comprises verifying that each of the peer nodes of the nomad blockchain network that forwarded the second cryptographic block across the nomad blockchain network and to the first peer node of the core blockchain network have actually been assigned to the reverse channel.

4. The system of claim 3, wherein the second metadata further comprises a listing of one or more peer nodes of the core blockchain network assigned to the reverse channel, wherein the first peer node of the core blockchain network is further configured to:
add an identification of the first peer node of the core blockchain network to the second metadata; and
provide the second block and the updated second metadata to a second peer node of the core blockchain network assigned to the reverse channel as listed in the second metadata.

5. The system of claim 3, wherein the second metadata comprises an original routing path comprising an identify of at least a second peer node of the core blockchain network to which the second cryptographic block is to be sent.

6. The system of claim 5, wherein the second metadata further comprises an indicator of whether the first peer node of the core blockchain network is permitted to alter the original routing path, wherein the first peer node of the core blockchain network is further configured to:
alter the routing path when the indicator indicates that the first peer node of the core blockchain network is permitted to alter the original routing path; and
provide the second block to a third peer node of the core blockchain network different than the second peer node of the core blockchain network as indicated by the original routing path.

7. The system of claim 3, wherein the first peer node of the core blockchain network is further configured to:
detect a change in one or more conditions associated with the core blockchain network; and
alter the original routing path when the change in the one or more conditions is detected.

8. The system of claim 1, further comprising:
a second nomad blockchain network intermittently connected to the core blockchain network;
a plurality of peer nodes of a second nomad blockchain network;
a plurality of orderer nodes of the second nomad blockchain network;
wherein the channel gateway is further configured to create a cryptographically-separated, second forward logical channel and a cryptographically-separated, second reverse logical channel, and for assigning all of the orderer nodes of the core blockchain network, at least two peer nodes of the core blockchain network, and the plurality of peer nodes of the second nomad blockchain network to the second forward logical channel and for assigning all of the plurality of orderer nodes of the second nomad blockchain network, at least two peer nodes of the second nomad blockchain network and the plurality of peer nodes of the core blockchain network to the second logical reverse channel;
wherein the first peer node of the core blockchain network assigned to the reverse logical channel and to the second reverse channel is configured to:
receive a third cryptographic block from the second logical reverse channel after the core blockchain network and the second nomad blockchain network are in communication with each other;
determine that each of the second cryptographic block and the third cryptographic block reference a same entity;
in response to determining that each of the second cryptographic block and the third cryptographic block reference a same entity, reconciling the second cryptographic block and the third cryptographic block to produce a fourth cryptographic block; and
publishing the fourth cryptographic block on the forward logical channel and the second forward logical channel.

9. The system of claim 1, wherein the at least two peer nodes of the core blockchain network are each configured to:
detect an anomalous condition associated with the second cryptographic block;
in response to detecting an anomalous condition of the second cryptographic block, restricting replication of the second cryptographic block to a list of known-safe peer nodes of the reverse channel.

10. The system of claim 1, further comprising:
a second nomad blockchain network intermittently coupled to the nomad blockchain network;
a plurality of peer nodes of the second nomad blockchain network;
a plurality of orderer nodes of the second nomad blockchain network;
wherein the channel gateway is further configured to create a cryptographically-separated, second forward logical channel and a cryptographically-separated, second reverse logical channel, to assign all of the orderer nodes of the nomad blockchain network, at least two peer nodes of the nomad blockchain network and the plurality of peer nodes of the second nomad blockchain network to the second forward logical channel, and to assign all of the orderer nodes of the second nomad blockchain network, at least two peer nodes of the second nomad blockchain network and the plurality of peer nodes of the nomad blockchain network to the second reverse channel;
wherein:
when the nomad blockchain network and the second nomad blockchain network are disconnected from each other, a first peer node of the nomad blockchain network is configured to publish the first cryptographic block on the second forward channel and a first peer node of the second nomad blockchain network is configured to publish a third cryptographic block on the second reverse channel; and
when the nomad blockchain network and the second nomad blockchain network become connected to each other after the first cryptographic block has been published on the second forward channel, a first peer node of the second nomad blockchain network receives the first cryptographic block from the first peer node of the nomad blockchain network, and the first peer node of the nomad blockchain network receives the third cryptographic block from the first peer node of the second nomad blockchain network.

11. A method for facilitating assured data exchanges between peer nodes of a core blockchain network and peer nodes in a nomad blockchain network intermittently-connected to the core blockchain network, comprising:
creating a cryptographically-separated, forward channel and a cryptographically-separated, reverse channel;
assigning all of a plurality of orderer nodes of the core blockchain network, at least two peer nodes of the core blockchain network, and a plurality of peer nodes of the nomad blockchain network to the forward channel;
assigning all of a plurality of orderer nodes of the nomad blockchain network, at least two peer nodes of the nomad blockchain network and a plurality of peer nodes of the core blockchain network to the reverse channel;
wherein:
when the core blockchain network and the nomad blockchain network are disconnected from each other, publishing a first cryptographic block on the forward channel by a first peer node of the core blockchain network and publishing a second cryptographic block on the reverse channel by a first peer node of the nomad blockchain network; and
when the core blockchain network and the nomad blockchain network are re-connected to each other after the first cryptographic block and the second cryptographic block have been published, receiving the first cryptographic block from the first peer node of the core blockchain network by a second peer node of the nomad blockchain network, and receiving the second cryptographic block from the first peer node of the nomad blockchain network by a second peer node of the core blockchain network.

12. The method of claim 11, further comprising:
receiving a plurality of transaction proposals from a gateway coupled to one or more client devices;
providing the plurality of transaction proposals to all of the ordering peers in the core blockchain network;
ordering the plurality of transactions by the ordering peers in the core blockchain network to produce an ordered plurality of transactions;
validating the ordered plurality of transactions by the at least two peer nodes of the core blockchain network;
when the plurality of transactions are validated, publishing the first cryptographic block on the forward channel, thus making the first cryptographic block available to any peer node of the core blockchain network assigned to the forward channel; and
after the core blockchain network and the nomad blockchain network have re-connected to each other, providing the first cryptographic block to at least one of the plurality of peer nodes of the nomad blockchain network by a second peer node of the core blockchain network for replication to the other peer nodes of the nomad blockchain network.

13. The method of claim 11, wherein first metadata is associated with the first cryptographic block and second metadata is associated with the second cryptographic block, the method further comprising:
receiving the second block by a first peer node of the core blockchain network from a first peer node of the nomad blockchain network after the core blockchain network and the nomad blockchain network have re-connected with each other; and
verifying, by the first peer node of the core blockchain network, an authenticity of the second block by:
validating a cryptographic signature contained within the second cryptographic block; and
validating the second metadata, the second metadata comprising a route history, the route history comprising a listing of any peer nodes of the nomad blockchain network that forwarded the second block across the nomad blockchain network and to the first peer node of the core blockchain network, wherein validating the second metadata comprises verifying that each of the peer nodes of the nomad blockchain network that forwarded the second cryptographic block across the nomad blockchain network and to the first peer node of the core blockchain network have actually been assigned to the reverse channel.

14. The method of claim 13, wherein the second metadata further comprises a listing of one or more peer nodes of the core blockchain network assigned to the reverse channel, the method further comprising:
adding, by the first peer node of the core blockchain network, an identification of the first peer node of the core blockchain network to the second metadata; and
providing, the first peer node of the core blockchain network, the second block and the updated second metadata to a second peer node of the core blockchain network assigned to the reverse channel as listed in the second metadata.

15. The method of claim 13, wherein the second metadata comprises an original routing path comprising an identify of at least a second peer node of the core blockchain network to which the second cryptographic block is to be sent.

16. The method of claim 15, wherein the second metadata further comprises an indicator of whether the first peer node of the core blockchain network is permitted to alter the original routing path, the method further comprising:
altering, by the first peer node of the core blockchain network, the routing path when the indicator indicates that the first peer node of the core blockchain network is permitted to alter the original routing path; and
providing, by the first peer node of the core blockchain network, the second block to a third peer node of the core blockchain network different than the second peer node of the core blockchain network as indicated by the original routing path.

17. The method of claim 13, further comprising:
detecting, by the first peer node of the core blockchain network, a change in one or more conditions associated with the core blockchain network; and
altering, by the first peer node of the core blockchain network, the original routing path when the change in the one or more conditions is detected.

18. The method of claim 11, further for facilitating assured data exchanges between the core blockchain network and a second nomad blockchain network intermittently connected to the core blockchain network, the method further comprising:
creating a cryptographically-separated, second forward channel and a cryptographically-separated, second reverse channel;
assigning all of the orderer nodes of the core blockchain network, at least two peer nodes of the core blockchain network, and a plurality of peer nodes of the second nomad blockchain network to the second forward channel;
assigning all of a plurality of orderer nodes of the second nomad blockchain network, at least two peer nodes of the second nomad blockchain network and the plurality of peer nodes of the core blockchain network to the second reverse channel;
receiving, by the first peer node of the core blockchain network assigned to the reverse channel and to the second reverse channel, a third cryptographic block from the second reverse channel after the core blockchain network and the second nomad blockchain network are in communication with each other;
determining, by the first peer node of the core blockchain network, that each of the second cryptographic block and the third cryptographic block reference a same entity;
in response to determining that each of the second cryptographic block and the third cryptographic block reference a same entity, reconciling, by the first peer node of the core blockchain network, the second cryptographic block and the third cryptographic block to produce a fourth cryptographic block; and
publishing the fourth cryptographic block on the forward channel and the second forward channel.

19. The method of claim 11, further comprising:
detecting, by a first peer node of the at least two peer nodes of the core blockchain network, an anomalous condition associated with the second cryptographic block;
in response to detecting an anomalous condition of the second cryptographic block, restricting, by the first peer node of the at least two peer nodes, replication of the second cryptographic block to a list of known-safe peer nodes of the reverse channel.

20. The method of claim 11, further for facilitating assured data exchanges among the core blockchain network, the nomad blockchain network and a second nomad blockchain network intermittently connected to the nomad blockchain network, the method further comprising:
creating a cryptographically-separated, second forward channel and a cryptographically-separated, second reverse channel;
assigning all of the orderer nodes of the nomad blockchain network, at least two peer nodes of the nomad blockchain network and a plurality of peer nodes of the second nomad blockchain network to the second forward channel;
assigning all orderer nodes of the second nomad blockchain network, at least two peer nodes of the second nomad blockchain network and the plurality of peer nodes of the nomad blockchain network to the second reverse channel;
publishing the first cryptographic block on the second forward channel by a first peer node of the nomad blockchain network when the nomad blockchain network and the second nomad blockchain network are disconnected from each other;
publishing a third cryptographic block on the second reverse channel by a first peer node of the second nomad network when the nomad blockchain network and the second nomad blockchain network are disconnected from each other; and
receiving, by a first peer node of the second nomad blockchain network, the first cryptographic block from the first peer node of the nomad blockchain network after the nomad blockchain network and the second nomad blockchain network become connected to each other after the first cryptographic block has been published on the second forward channel; and
receiving, by the first peer node of the nomad blockchain network, the third cryptographic block from the first peer node of the second nomad blockchain network after the nomad blockchain network and the second nomad blockchain network become connected to each other after the third cryptographic block has been published on the second reverse channel.
